(19) United States
(12) Patent Application Publication
(10) Pub. No.: US 2008/0159190 A1
(43) Pub. Date: Jul. 3, 2008

(54) Wireless Transmission Method, Apparatus, And System

(75) Inventor: Wenglun Tsao, Hsin-Chu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/617,155

(22) Filed: Dec. 28, 2006

(51) Int. Cl. H04B 7/00

(52) U.S. Cl. 370/310

(57) ABSTRACT

A wireless transmission system for transmitting aggregated data units from a first layer to a third layer comprises an apparatus. The apparatus includes a receiver and a processor. The system transmits the aggregated data units from the first layer to the third layer. A wireless transmission method, performed in a second layer for transmitting data from a first layer to a third layer comprises the following steps: retrieving information related to unacknowledged frames from the first layer, aggregating the unacknowledged frames into a predetermined length to the third layer according to the information. The unacknowledged frames form the data.

### CROSS-REFERENCES TO RELATED APPLICATIONS

Not applicable.

### BACKGROUND OF THE INVENTION

1. Field of the Invention

The present invention relates to wireless transmission system comprising transmission apparatus for transmitting data from a first layer to a third layer, and method thereof. More particularly, the present invention relates to wireless transmission system comprising transmission apparatus for transmitting aggregated data from a first layer to a third layer, and for padding the transmission and method thereof.

2. Descriptions of the Related Art

Generally, wireless LAN systems comprise three layers: a first layer, i.e. a host, that transmits data or frames, such as a MAC service data unit (MSDU) to a second layer; a second layer that is configured to buffer the transmitted data or frames from the host and transmit the data or frames to a third layer. Each MSDU has a description, such as a TX descriptor, recording the attributes and addresses of the MSDU. The address locates the memory storing the MSDU. Here, the MSDU is stored in a buffer in the second layer, in addition to hardware, such as a chip, when the second layer randomly gains transmission opportunities (TXOP) for transmitting the MSDU stored in the buffer. The TXOP is an opportunity for transmitting data units from the first layer to the third layer. Then, the system transmits the MSDU during the TXOP. Once the MSDU is successfully transmitted, the buffer releases the MSDU. If unsuccessful, the chip re-gains a new TXOP and re-transmits the MSDU. It is important to note that only one MSDU can be processed at a time.

During transmission, the system has to meet a critical time requirement. That is, the transmission of consecutive MSDUs cannot lag more than a short inter frame space (SIFS). If longer, the TXOP will be forced to terminate and the system would have to find another TXOP for transmission. Generally, the SIFS is 10 μs.

FIG. 1 shows a flow chart of a conventional transmission of a wireless LAN system. In step 101, the system gains a TXOP for transmitting data. In step 102, a TX descriptor is read, and an MSDU pointed by the TX descriptor is stored in a buffer. The MSDU is transmitted in a MAC protocol data unit (MPDU) format.

In step 103, the MSDU is transmitted to the third layer. Then, step 104 is executed to determine if an acknowledgement from the third layer is received, wherein the acknowledgement indicates successful receipt of the MSDU by the third layer. If the determination is YES, then in step 105, a transmission status is returned to release the successfully transmitted MSDU. In step 106, a new MSDU is read for transmission. In step 104, if the determination in step 104 is NO, then it goes back to step 103 and the MSDU is re-transmitted again. After step 106, step 107 is executed to determine if the TXOP has ended; if the determination is NO, then step 102 is executed again and if the determination is YES, then step 108 is executed to end the transmission during the TXOP.

A new wireless LAN standard, such as the IEEE 802.11N standard, requires a transmission of a plurality of MSDUs at a time. With the IEEE 802.11N standard, a plurality of MSDUs can be aggregated as an A-MSDU, a MSDU or an A-MSDU is carried in a MPDU, and a plurality of MPDUs can be aggregated as an A-MPDU.

A MSDU or an A-MSDU is carried in a MPDU. A plurality of MPDUs can be aggregated as an A-MPDU.

The A-MSDU and the A-MPDU both have limitations on the length of data. During transmission, the first layer may continuously transmit a new MSDU to the second layer and the new MSDU would be aggregated with these MSDUs which are re-transmitted in a follow-up transmission. However, the IEEE 802.11N standard does not define the transmission of the MSDUs.

Accordingly, a solution that can transmit a plurality of data units simultaneously and meet the critical time requirement is urgently needed in this field.

### SUMMARY OF THE INVENTION

The primary objective of this invention is to provide a wireless transmission method, performed in a second layer, for transmitting data from a first layer to a third layer. The wireless transmission method comprises steps of: retrieving information related to unacknowledged frames from the first layer; and aggregating the unacknowledged frames in a predetermined length to the third layer according to the information. The unacknowledged frames form the data.

Another objective of this invention is to provide a wireless transmission apparatus of a second layer for transmitting data from a first layer to a third layer. The wireless transmission apparatus comprises a receiver and a processor. The receiver is configured for retrieving information related to unacknowledged frames from the first layer. The processor is configured for aggregating the unacknowledged frames in a predetermined length to a third layer according to the information. The unacknowledged frames form the data.

Another objective of this invention is to provide a wireless transmission system. The wireless transmission system comprises a first layer, a second, and a third layer. The first layer is configured for generating unacknowledged frames. The second layer is configured for retrieving information related to the unacknowledged frames and for aggregating the unacknowledged frames in a predetermined length according to the information. The third layer is configured for transmitting the aggregated frames.

Yet a further objective of this invention is to provide a wireless transmission apparatus of a second layer for transmitting data from a first layer to a third layer. The wireless transmission apparatus comprises means for retrieving information related to unacknowledged frames from the first layer, and means for aggregating the unacknowledged frames in a predetermined length to a third layer according to the information. The unacknowledged frames form the data.

Accordingly, a plurality of data units can be transmitted simultaneously and meet the critical time requirement.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a flow chart of a conventional transmission of wireless LAN system;

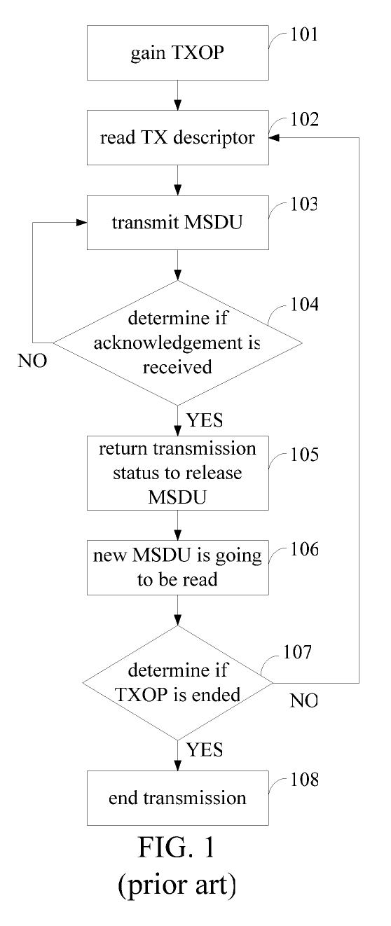

FIG. 2 is a flow chart of a transmission of a first embodiment of the present invention;

FIG. 3(a)-FIG. 3(e) are diagrams of a aggregation procedures of a second embodiment of the present invention;

FIG. 4(a)-FIG. 4(b) are diagrams of a padding transmission of a third embodiment of the present invention;

FIG. 5(a)-FIG. 5(b) are diagrams of a padding transmission of a fourth embodiment of the present invention; and

FIG. 6 is a fifth embodiment of the present invention.

### DESCRIPTION OF THE PREFERRED EMBODIMENT

In this specification, the term “in response to” is defined as “replying to” or “reacting to.” For example, “in response to a signal” means “replying to a signal” or “reacting to a signal” without necessity of direct signal reception.

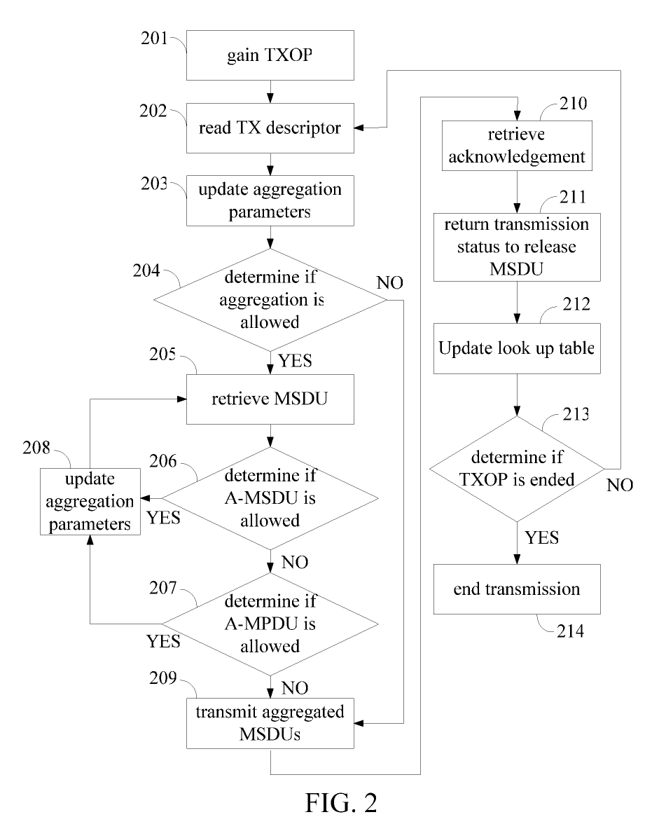

The first embodiment of the present invention is a method performed in the second layer for transmitting data from a first layer to a third layer. FIG. 2 shows a flow chart of this method. In step 201, a TXOP is gained. The data units are in frame format and are denoted as MSDU, A-MSDU, MPDU, and A-MPDU. In step 202, a TX descriptor is read. The TX descriptor comprises the attributes and address of the data units. The address points to the location of a memory storing the data units, and the data units are unacknowledged in step 202. In step 203, aggregation parameters in a look up table are updated. In this embodiment, the aggregation parameters comprise MSDU-count, Total-length, A-MSDU-bitmap, and ACK-bitmap. The look up table is an aggregation scoreboard. In step 204, processing of the aggregation is determined. If the determination is YES, then step 205 is executed and another TX descriptor is read to retrieve an MSDU for aggregation according to the ACK-bitmap, wherein the ACK-bitmap records the last transmission result of every MSDU. If the determination is NO in step 204, then step 209 is executed. Details of step 209 are described below. After step 205, step 206 is executed to determine if A-MSDU is allowed to aggregate the retrieved MSDU in step 205. If the determination is YES, then step 208 is executed to update the aggregation parameters in the look up table. If the determination is NO, then step 207 is executed to determine if A-MPDU is allowed to aggregate the MSDU retrieved in step 205. If the determination is YES, then step 208 is executed to update the aggregation parameters. After step 208, step 205 is executed again to retrieve another MSDU.

In this embodiment, a negative determination in step 207 indicates that both the A-MSDU and A-MPDU are not allowed to aggregate more MSDUs. The allowed MSDUs for aggregation are aggregated according to the look up table during transmission This feature is also known as the on-the-fly mode of transmission, where an aggregation scoreboard is generated according to the aggregation parameters of the MSDUs allowed for integration. In step 208, the A-MSDU-bitmap of the look up table stores target formats of the MSDUs allowed for transmission, wherein the target formats represent the transmission format of the MSDUs. Step 209 is then executed to transmit the aggregated MSDUs to the third layer according to the look up table (an aggregation scoreboard), and the aggregated MSDUs are transmitted in sequence.

In step 210, an acknowledgement of transmission is retrieved from the next layer and the ACK-bitmap in the look up table is updated according to the acknowledgement. In step 211, the transmission status is returned to release the successfully transmitted MSDUs, wherein the transmitted MSDUs are released only if the first MSDU of the consecutively aggregated MSDUs is successfully transmitted. The acknowledgement also indicates failed MSDUs, denoted as unacknowledged MSDUs, which are formed by unacknowledged frames. Thus, the acknowledgement relates to the transmission result of a plurality of frames, and indicates if the frames are consecutive or not. The unacknowledged MSDUs are then aggregated with new MSDUs received from the first layer and transmitted again in the next transmission. In step 212, the look up table (aggregation scoreboard) is updated according to the acknowledgement, and the unacknowledged MSDUs can be selected for aggregation according to the look up table. Then, step 213 is executed to determine if the TXOP has ended. If the determination is NO, then step 202 is executed again to read another TX descriptor. If the determination is YES, then step 214 is executed to end the transmission in the TXOP.

It is noted that the present invention is not limited to the execution orders of the above steps. For example, step 206 may be executed after step 207 is executed.

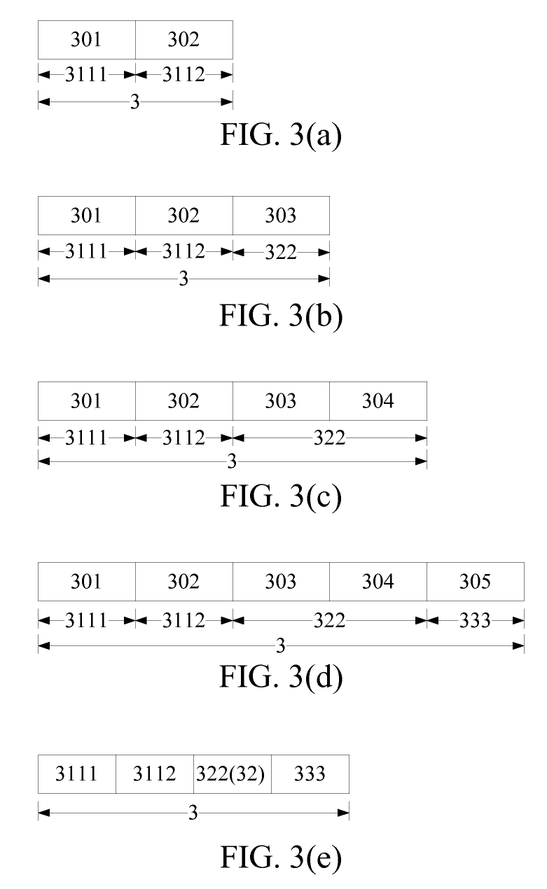

FIG. 3(a) to FIG. 3(e) are diagrams of aggregation procedures for A-MPDUs with A-MSDUs of the second embodiment. The aggregation procedure is operated in the second layer, and aggregated MSDUs are transmitted to the third layer. The aggregation interprets an MSDU as a data unit, with a plurality of MSDUs aggregated as an A-MSDU, and a plurality of MPDUs aggregated as an A-MPDU. More specifically, A-MSDU-bitmap will need 16 bits if ACK-bitmap is 8 bits, since each MSDU needs 2 bits to represent ‘0’, ‘1’, ‘2’, and ‘3’.

The numbers and values of the bits are illustrated for clarity and are not a limitation of the present invention. The ACK-bitmap bit can be ‘0’ or ‘1’, wherein a bit ‘1’ means a successfully transmitted MSDU and a bit ‘0’ means a failed transmitted MSDU. The A-MSDU-bitmap bit can be ‘0’, ‘1’, ‘2’ or ‘3’. A bit ‘0’ means one MPDU solely comprises the MSDU represented by the bit ‘0’. A bit ‘1’ means one MPDU comprises an A-MSDU, and the MSDU represented by the bit ‘1’ is a first MSDU in the A-MSDU.

A bit ‘3’ means one MPDU comprises an A-MSDU, and the MSDU represented by the bit ‘3’ is a last MSDU in the A-MSDU. A bit ‘2’ means one MPDU comprises an A-MSDU, and the MSDU represented by the bit ‘2’ is an intermediate MSDU in the A-MSDU. In the second embodiment, the predetermined length of the A-MPDU is 10 k bytes, the predetermined length of A-MSDU, is 4 K bytes, the present ACK-bitmap is 00111000 and the present A-MSDU-bitmap is 00123000 before aggregation. The first bit and the second bit are both 0, which means that during the last transmission, the first and second MSDUs were transmitted in MPDUs formality separately, but failed in transmission. The third bit to the fifth bit of the ACK-bitmap are all ‘1’, which means that during the last transmission before aggregation, the third MSDU to the fifth MSDU were aggregated as another A-MSDU and put in another MPDU for transmission, and were successfully transmitted. Before aggregation, 3 new MSDUs received from the first layer and respectively denoted as MSDU3 303, MSDU4 304, and MSDU5 305.

Since the first MSDU of the last aggregation fails to be transmitted, the successfully transmitted MSDUs are not released. The first MSDU and the second MSDU are respectively denoted as MSDU1 301 and MSDU2 302 and will be transmitted in MPDU format again and denoted as MPDU1 3111 and MPDU2 3112 for transmission.

In the beginning, the MSDU1 301 and the MSDU2 302 both with a 2 k byte length are read and determined as the MPDU1 3111 and MPDU2 3112 for transmission, as shown in FIG. 3(a).

Then, an MSDU3 303 with a 2 k byte length is read and put into an MPDU3 322. The MPDU3 322 is then determined if it can be aggregated in an A-MPDU. Since the predetermined length of the A-MPDU is 10 k bytes, the MPDU3 322 can be aggregated into an A-MPDU denoted as A-MPDU 3. At this time, the MPDU3 322 only comprises the MSDU3 303 as shown in FIG. 3(b). Thus, the MSDU3 303 is represented as a ‘0’ in the A-MSDU-bitmap and the A-MSDU-bitmap is 00123000.

Then, an MSDU4 304 with a 2 k byte length is read and determined for being aggregated with the MSDU3 303 and forming an A-MSDU. Since the predetermined length of an A-MSDU is 4 k bytes, the MSDU4 304 can be aggregated into an A-MSDU 32 with the MSDU3 303. At this time, the MSDU3 303 and the MSDU4 304 are determined to be transmitted in the MPDU3 322 format as shown in FIG. 3(c). Thus, the MSDU3 303 is represented as a ‘1’ in the A-MSDU-bitmap, the MSDU4 304 is represented as a ‘3’, and the A-MSDU-bitmap is 00123130. The A-MSDU 32 reaches the predetermined length when aggregating the MSDU3 303 and MSDU4 304.

Finally, an MSDU5 305 with a 2 k byte length is read. According to the same aforementioned principle, the MSDU5 305 can be put into an MPDU4 333 for transmission. At this time, the MPDU4 333 only comprises the MSDU5 305 as shown in FIG. 3(d). Thus, the MSDU5 305 is represented as a ‘0’ in the A-MSDU-bitmap and the A-MSDU-bitmap is 00123130. The MSDU-count is 5, the total-length is 10 k bytes, and the A-MSDU-bitmap is 00123130.

The MPDU1 3111, MPDU2 3112, MPDU3 322 and MPDU4 333 are included in the A-MPDU 3 for transmission as shown in FIG. 3(e). The MPDU3 322 comprises the A-MSDU 32. Then, the aggregation parameters and the ACK-bitmap are read, and the aggregated MSDUs are transmitted to the third layer in the target formats, such as MPDU or A-MPDU formats, wherein the target formats represent the transmission format of the aggregated MSDUs.

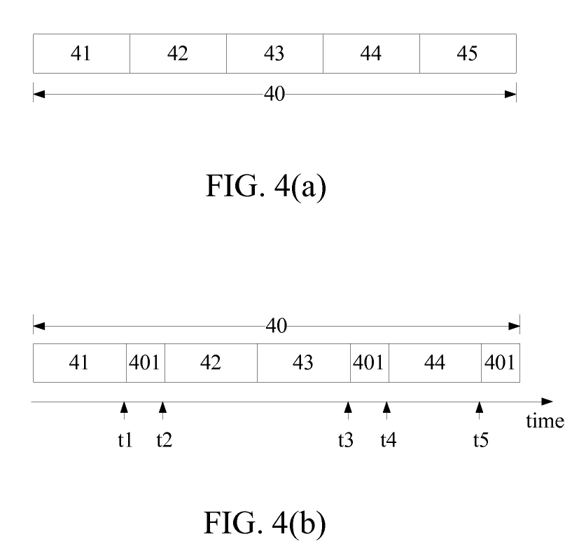

To meet the critical time requirement, the present invention provides a method of padding the transmission when the second layer fails to timely transmit any partition of the aggregated unacknowledged frames. FIG. 4(a) and FIG. 4(b) are diagrams of the padding transmission of aggregated MPDUs of the third embodiment. In the third embodiment, the space of a buffer in the second layer is equal to or larger than the length of one MSDU, which means one MSDU can be fully buffered and transmitted to the third layer without underflow. The third embodiment assumes that a TXOP is gained and five MPDUs 41, 42, 43, 44, 45 are aggregated for transmission. In FIG. 4(a), an A-MPDU 40 comprises the five MPDUs 41, 42, 43, 44, 45 for transmission. If there is no underflow, the five MPDUs 41, 42, 43, 44, 45 can be transmitted to the third layer. FIG. 4(b) shows a transmission with underflow. At time t1, the transmission of an MPDU1 41 is finished, but the next MPDU2 42 is not ready. A padding delimiter (PD) 401 is then transmitted. The padding will continue until the MPDU2 42 is ready for transmission at time t2. Similarly, at time t3, the MPDU4 44 is not ready after the MPDU3 43 is transmitted so the PD 402 is transmitted. At time t4, the MPDU4 44 is ready for transmission. At time t5, the MPDU4 44 is transmitted, but the residual space of the A-MPDU is not enough for transmitting an MPDU5 45. Thus, the space is padded by a PD 403.

In the third embodiment, all five MSDUs cannot be transmitted when underflow occurs. By padding the transmission, four out of the five MSDUs can still be transmitted, keeping the TXOP available.

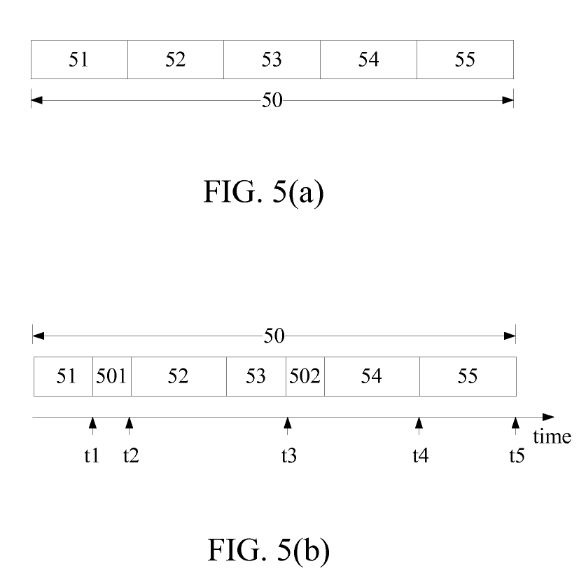

FIG. 5(a) and FIG. 5(b) are diagrams of the padding transmission of the aggregated MPDUs of the fourth embodiment. In the fourth embodiment, the space of the buffer in the second layer is smaller than the length of one MSDU. The fourth embodiment assumes that a TXOP is gained and five MPDUs 51, 52, 53, 54, 55 are aggregated for transmission.

In FIG. 5(a), an A-MPDU 50 comprises five MPDUs 51, 52, 53, 54, 55 for transmission. If there is no underflow, the five MPDUs 51, 52, 53, 54, 55 can be transmitted to the third layer. FIG. 5(b) shows transmission with underflow. At time t1, the MPDU1 51 is incompletely transmitted, which means that parts of the MPDU1 51 stored in the buffer run out and underflow occurs. At this time, the transmission of MPDU1 51 is skipped, and the residual space of the MPDU1 51 is padded by a PD 501. At time t2, a MPDU2 52 is ready for transmission. At time t3, an MPDU3 53 is incompletely transmitted, and the residual space of the MPDU3 53 is padded by a PD 502. At time t4, an MPDU4 54 is transmitted. At time t5, an MPDU5 55 is transmitted.

In the fourth embodiment, when each time underflow occurs, the current MSDU is skipped. By padding the residual space of the skipped MSDU, other MSDUs can still be transmitted, keeping the TXOP available.

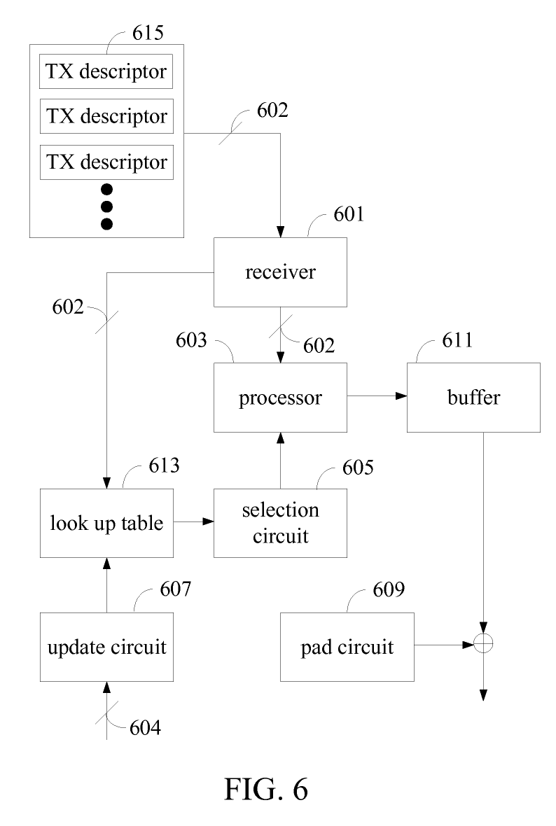

A fifth embodiment of the present invention is shown in FIG. 6, which is a wireless transmission apparatus of the second layer for transmitting data from a first layer to a third layer. The wireless transmission apparatus comprises a receiver 601, a processor 603, a selection circuit 605, an update circuit 607, a pad circuit 609, a buffer 611, and a look up table 613. The receiver is configured for retrieving information related to unacknowledged data units from the first layer; thus, the receiver reads information 602 contained in a TX descriptor 615. The processor 603 is configured for aggregating the unacknowledged data units according to the information 602, wherein the unacknowledged data units are selected by the selection circuit 605. The information 602 is also applied for updating aggregation parameters in the look up table 613. The selection circuit 605 is configured for selecting the unacknowledged data units according to the look up table 613. The update circuit 607 is configured for updating the look up table 613 when receiving an acknowledgement 604 from the third layer. After aggregation is completed by the processor 603, the buffer 611 buffers the content of the unacknowledged data units before transmission. The pad circuit 609 is configured for padding the transmission during underflow. The functions of the receiver 601, the processor 603, the selection circuit 605, the update circuit 607, the pad circuit 609, and the buffer 611 are similar to those of the corresponding functions recited in the first, second, third and fourth embodiments, and thus, may execute all of the steps recited in these above-mentioned embodiments.

The first, second, third, fourth and fifth embodiments can be applied to a wireless transmission system configured to transmit data from a first layer to a third layer.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A wireless transmission method, performed in a second layer, for transmitting data from a first layer to a third layer, comprising steps of:
retrieving information related to unacknowledged frames from the first layer; and
aggregating the unacknowledged frames in a predetermined length to the third layer according to the information;
wherein the unacknowledged frames form the data.

2. The wireless transmission method as claimed in claim 1, further comprising a step of selecting the unacknowledged frames for aggregation according to a look up table.

3. The wireless transmission method as claimed in claim 2, further comprising a step of updating the look up table when receiving an acknowledgement from the third layer, wherein the acknowledgement related to at least one frame.

4. The wireless transmission method as claimed in claim 2, further comprising a step of updating the look up table when receiving an acknowledgement from the third layer, wherein the acknowledgement related to a plurality of frames and the plurality of frames can be consecutive or not.

5. The wireless transmission method as claimed in claim 1, wherein each of the unacknowledged frames is a data unit formed by the first layer.

6. The wireless transmission method as claimed in claim 1, wherein the information comprises addresses pointing to locations of a memory storing the unacknowledged frames.

7. The wireless transmission method as claimed in claim 1, wherein the information comprises a target format for at least one of the unacknowledged frames.

8. The wireless transmission method as claimed in claim 1, wherein a processing time of the retrieving step is within 10 μs.

9. The wireless transmission method as claimed in claim 1, further comprising a step of padding the transmission when the second layer fails to timely transmit any partition of the aggregated unacknowledged frames.

10. The wireless transmission method as claimed in claim 1, further comprising a step of providing a buffer for buffering a content of the unacknowledged frames before transmitting the data.

11. The wireless transmission method as claimed in claim 10, wherein a size of the buffer is larger than one frame.

12. The wireless transmission method as claimed in claim 10, wherein a size of the buffer is smaller than one frame.

13. The wireless transmission method as claimed in claim 12, further comprising a step of selecting the unacknowledged frames according to a look up table.

14. The wireless transmission method as claimed in claim 13, further comprising a step of updating the look up table when receiving an acknowledgement from the third layer, wherein the acknowledgement related to at least one frame.

15. The wireless transmission method as claimed in claim 13, further comprising a step of updating the look up table when receiving an acknowledgement from the third layer, wherein the acknowledgement related to a plurality of frames and the plurality of frames can be consecutive or not.

16. The wireless transmission method as claimed in claim 12, wherein each of the unacknowledged frames is a data unit formed by the first layer.

17. The wireless transmission method as claimed in claim 12, wherein the information comprises addresses pointing to locations of a memory storing the unacknowledged frames.

18. The wireless transmission method as claimed in claim 12, wherein the information comprises a target format for at least one of the unacknowledged frames.

19. The wireless transmission method as claimed in claim 12, wherein a processing time of the retrieving step is within 10 μs.

20. The wireless transmission method as claimed in claim 12, further comprising a step of padding the transmission when the second layer fails to timely transmit any partition of the aggregated unacknowledged frames.

21. A wireless transmission apparatus of a second layer for transmitting data from a first layer to a third layer, comprising:
a receiver for retrieving information related to unacknowledged frames from the first layer; and
a processor for aggregating the unacknowledged frames in a predetermined length to a third layer according to the information;
wherein the unacknowledged frames form the data.

22. The wireless transmission apparatus as claimed in claim 21, further comprises a selection circuit for selecting the unacknowledged frames for aggregation according to a look up table.

23. The wireless transmission apparatus as claimed in claim 22, further comprising an update circuit for updating the look up table when receiving an acknowledgement from the third layer.

24. The wireless transmission apparatus as claimed in claim 22, further comprising an update circuit for updating the look up table when receiving an acknowledgement from the third layer, wherein the acknowledgement related to a plurality of frames and the plurality of frames can be consecutive or not.

25. The wireless transmission apparatus as claimed in claim 21, wherein each of the unacknowledged frames is a data unit formed by the first layer.

26. The wireless transmission apparatus as claimed in claim 21, wherein the information comprises addresses pointing to locations of a memory storing the unacknowledged frames.

27. The wireless transmission apparatus as claimed in claim 21, wherein the information comprises a target format for at least one of the unacknowledged frames.

28. The wireless transmission apparatus as claimed in claim 21, wherein a processing time of the receiver is within 10 μs.

29. The wireless transmission apparatus as claimed in claim 21, further comprising a pad circuit for padding the transmission when the second layer fails to timely transmit any partition of the aggregated unacknowledged frames.

30. The wireless transmission apparatus as claimed in claim 21, further comprising a buffer for buffering a content of the unacknowledged frames before the transmission of data.

31. The wireless transmission apparatus as claimed in claim 30, wherein a size of the buffer is larger than one frame.

32. The wireless transmission apparatus as claimed in claim 30, wherein a size of the buffer is smaller than one frame.

33. The wireless transmission apparatus as claimed in claim 32, further comprising a selection circuit for selecting the unacknowledged frames according to a look up table.

34. The wireless transmission apparatus as claimed in claim 33, further comprising an update circuit for updating the look up table when receiving an acknowledgement from the third layer.

35. The wireless transmission apparatus as claimed in claim 33, further comprising an update circuit for updating the look up table when receiving an acknowledgement from the third layer, wherein the acknowledgement related to a plurality of frames and the plurality of frames can be consecutive or not.

36. The wireless transmission apparatus as claimed in claim 32, wherein each of the unacknowledged frames is a data unit formed by the first layer.

37. The wireless transmission apparatus as claimed in claim 32, wherein the information comprises addresses pointing to locations of a memory storing the unacknowledged frames.

38. The wireless transmission apparatus as claimed in claim 32, wherein the information comprises a target format for at least one of the unacknowledged frames.

39. The wireless transmission apparatus as claimed in claim 32, wherein a processing time of the receiver is within 10 μs.

40. The wireless transmission apparatus as claimed in claim 32, further comprising a pad circuit for padding the transmission when the second layer fails to timely transmit any partition of the aggregated unacknowledged frames.

41. A wireless transmission system, comprising:
a first layer for generating unacknowledged frames;
a second layer for retrieving information related to the unacknowledged frames and for aggregating the unacknowledged frames in a predetermined length according to the information; and
a third layer for receiving the aggregated frames.

42. A wireless transmission apparatus of a second layer for transmitting data from a first layer to a third layer, comprising:
means for retrieving information related to unacknowledged frames from the first layer; and
means for aggregating the unacknowledged frames in a predetermined length to a third layer according to the information;
wherein the unacknowledged frames form the data.
